(19) United States
(12) Patent Application Publication
(10) Pub. No.: US 2003/0044497 A1
(43) Pub. Date: Mar. 6, 2003

(54) Process to treat fish with tasteless smoke or carbon monoxide through the respiratory and circulatory systems

(76) Inventor: William R. Kowalski, Honolulu, HI (US)

Correspondence Address: Martin E. Hsia, P. O. Box 939, Honolulu, HI, 96808-0939, US

(21) Appl. No.: 09/932,622

(22) Filed: Aug. 17, 2001

(51) Int. Cl. A23C 1/00

(52) U.S. Cl. 426/315

(57) ABSTRACT

A process and apparatus for treating fish or other animals by introducing tasteless smoke or carbon monoxide into the respiratory system, so that it is absorbed into the edible muscle tissue through the circulatory system. In one embodiment, tasteless smoke or carbon monoxide is entrained or dissolved in water in which fish are swimming. In another embodiment, tasteless smoke or carbon monoxide is introduced into a foam that is applied to the fish. Devices for entraining or dissolving the tasteless smoke or carbon monoxide into water or foam are also described.

### TECHNICAL FIELD

This invention relates to a process to treat whole fish or meat through the introduction of tasteless, super-purified smoke or carbon monoxide through the animal's respiratory and circulatory systems to its edible muscle tissue. The tasteless, super-purified smoke or carbon monoxide is used to preserve the freshness, color, texture and natural flavor of the edible muscle tissue. These characteristics are the vital signs of quality in meat and seafood, hereinafter referred to as “vitality.”

Treating edible muscle tissue with tasteless, super-purified smoke or carbon monoxide has been demonstrated to be effective in prolonging the vitality of fresh seafood. These preservative agents are normally applied to the edible muscle tissue of fish or animals by external exposure or needle injection after they have been killed and filleted into more convenient product forms such as loins, steaks or fillets. This is a costly and time-consuming procedure.

In the case of fish, which are highly perishable by nature, the time between when the animal first dies and when the tasteless, super-purified smoke or carbon monoxide is applied may be as long as two weeks. During this time oxidation occurs causing discoloration and other defects that reduce the value of the fish. Further, external exposure methods used to apply the tasteless, super-purified smoke or carbon monoxide can take an additional 48 hours or more before preserving the “vitality” characteristics. Internal exposure, needle injection methods of applying tasteless, super-purified smoke or carbon monoxide can be used to treat the fish more quickly, but these methods may result in needle holes or damage to the fish meat from gas pressure during injection.

This invention relates to reducing the time between the animal's live fresh state and the administering of tasteless, super-purified smoke or carbon monoxide to its edible tissue after death. Specifically, this invention includes two methods of application—one for wild seafood and one for farmed seafood—whereby tasteless, super-purified smoke or carbon monoxide is introduced through the respiratory and circulatory systems of the animal to preserve its vitality and increase its value.

Introducing the treatment gas into the animal's respiratory and circulatory systems immediately after capture and before slaughtering delays the onset of microbial spoilage and autolytic reactions that reduce the value of the product and make it less wholesome for human consumption. By “euthanizing” the fish through carbon monoxide asphyxiation, the fish's tissue becomes preserved with carboxymyoglobin inhibiting such microbial spoilage and autolytic reactions.

In Japan, the world's largest market for sashimi-quality tuna, more than 1.1 billion pounds of fresh and frozen sashimi-quality tuna are consumed annually. In order to maintain the vitality of frozen sashimi tuna, the seafood industry prevents the oxidation of the iron atom in myoglobin by freezing and holding the fish at ultra-cold temperatures of minus 76° F. (minus 60° C.). Because of the significant size of its sashimi tuna market, the Japanese seafood industry has made large capital infrastructure investments in ultra-cold, cold storage facilities.

In the U.S., however, where the demand for sashimi-quality tuna is much smaller, it is not practical or worthwhile for the seafood industry to make a similar large infrastructure investment to build new super cold storage facilities or to retrofit existing facilities. As a result, until recently the U.S. sashimi market has been limited to the availability of fresh tuna. Because it must be flown to the U.S. market, fresh sashimi-quality tuna sold in the U.S. is considerably more expensive than most of the frozen sashimi-quality tuna sold in Japan, which is shipped by inexpensive ocean freight.

The application of tasteless, super-purified smoke or carbon monoxide is an alternative to holding frozen seafood at ultra-low temperatures to retain its “vitality” characteristics. When carbon monoxide binds with the iron atom in the myoglobin molecule, the result is known as carboxymyoglobin. Carboxymyoglobin is desirable because of its stable organoleptic freshness characteristics and its stable red color.

With the external exposure or injection methods of treating fish with tasteless, super-purified smoke or carbon monoxide, loins, steaks and fillets can be stored at conventional U.S. cold storage temperatures of minus 20° F. The present invention expands this storage capability further by allowing fish in whole condition to be stored at conventional cold storage temperatures without discoloration and defects causing loss of value. In addition, the invention preserves the fresh like “vitality” characteristics at a much closer point to the death of the fish.

The invention has significant applications throughout the global seafood industry. In the future, fresh and frozen tuna processed in this manner may gain a share of the high-quality Japanese market of more than 1 billion pounds and $4 billion a year. The U.S. market for sashimi quality tuna, while not as large as Japan, is still significant and growing. In the year 2000, the U.S. imported more than 50 million pounds of fresh tuna, worth more than $150 million dollars. Frozen, treated sashimi can garner a share of this growing market.

The invention can be used for the salmon industry. Currently, world production of farmed salmon is estimated at approximately 1,000,000 metric tons, or 2.2 billion pounds. The value of this production can conservatively be estimated at $3.5 billion dollars.

To achieve the pinkish red color associated with wild salmon, salmon farmers add synthetic carotenoids to their feed to achieve the desired pigmentation at a cost of 15 percent of their production costs. By killing their fish by “euthanizing” them with tasteless, super-purified smoke or carbon monoxide, the salmon farmers will be able to achieve significant costs savings producing a more desirable, red-meated farmed salmon without the high cost of adding expensive synthetic carotenoids.

Worldwide, more than a million tons of tilapia are grown annually, but most of this fish is very low-value and is consumed locally in developing countries. U.S. imports of high-quality tilapia fillets reached 26 million pounds in the year 2000, an increase of more than 20 percent from the previous year. Using super-purified smoke or carbon monoxide to treat the tilapia offers significant advantages to the producers. It is a cost effective and non-traumatic method to kill the fish, and it enhances the fresh-like characteristics of tilapia that is frozen and later thawed.

Therefore, there is a need and great economic benefit for new technologies to better preserve the vitality of a variety of seafood species in both fresh and frozen form.

It is therefore an object of the present invention to introduce tasteless, super-purified smoke or carbon monoxide through the respiratory and circulatory systems of the animal.

It is a further object of the present invention to introduce tasteless, super-purified smoke or carbon monoxide into the blood stream of fish through gaseous exchange at the gills of fish.

It is still a further object of the present invention to apply the tasteless, super-purified smoke or carbon monoxide preservative to animals near the time of death.

It is still a further object of the present invention to kill or nearly kill the animal by tasteless, super-purified smoke or carbon monoxide asphyxiation.

It is still a further object of the present invention to introduce a treatment gas through the respiratory and circulatory systems of an animal.

It is still a further object of the present invention to use steps of the process for manufacturing tasteless, super-purified smoke of U.S. Pat. No. 5,972,401 to produce a raw treatment medium.

It is still a further object of the present invention to apply the tasteless, super-purified smoke or carbon monoxide preservative to fish that will be frozen whole.

It is still a further object of the present invention to dissolve or entrain tasteless, super-purified smoke or carbon monoxide in water for treatment of live fish in a tank.

It is still a further object of the present invention to entrain or dissolve tasteless, super-purified smoke or carbon monoxide in foam that is applied to the gills of fish.

It is still a further object of the present invention for tasteless, super-purified smoke or carbon monoxide that has been dissolved or entrained in water or foam to be respirable by fish.

It is still a further object of the present invention to regulate carbon monoxide content and exposure time of inspired fluids to control carboxyhemoglobin concentrations in the blood of fish.

It is still a further object of the present invention to regulate carboxyhemoglobin concentrations in the blood and the circulation time to control carboxymyoglobin concentrations in muscle tissue.

It is still a further object of the present invention to mass-treat groups of live fish with tasteless, super-purified smoke or carbon monoxide.

It is still a further object of the present invention for tasteless, super-purified smoke or carbon monoxide to be artificially respirated and pumped through the blood stream of the animal bypassing the natural respiratory and circulatory systems.

### BACKGROUND ART

The process for manufacturing tasteless, super-purified smoke for treating seafood to be frozen and thawed has been patented under U.S. Pat. No. 5,972,401 (incorporated herein by reference), which was granted to William R. Kowalski, inventor of the process described herein. Since 1997 the annual U.S. market for tasteless smoke and carbon monoxide treated seafood products has grown dramatically with tuna now at 20 million pounds, tilapia at 10 million pounds, and other species totaling an estimated 3 million pounds. The primary market is for tasteless smoke treated products, although carbon monoxide products are still being produced and sold. Both tasteless smoke treatment and carbon monoxide treatment are practiced by external exposure or needle injection methods.

U.S. Pat. No. 5,484,619 to Yamaoka et al (incorporated herein by reference) discloses a method and apparatus that use extra low temperature smoking of fish and meat to sterilize and prevent decomposition and discoloration while imparting an agreeable smoked taste and smell.

U.S. Pat. No. 4,522,835 to Woodruff et al (incorporated herein by reference) teaches a method of maintaining redness in fish and red meat by first subjecting such fish or meat to an oxygen deprived atmosphere and then exposing the fish or meat to a modified atmosphere containing a small amount of carbon monoxide.

U.S. Pat. No. 3,122,748 (incorporated herein by reference) to Beebe relates to a method of treating red meat with carbon monoxide to achieve the appearance of meat that has been freshly cut.

U.S. Pat. No. 6,001,396 (incorporated herein by reference) to Bayer et al discloses a method for improving the quality of frozen seafood by injection of substances into the flesh or circulatory system of live fish or whole seafood prior to cooking or freezing.

Japan patent application 2,957,912 to Yamaoka and Adachi (incorporated herein by reference) teaches a method for highly efficient preservation treatment of fish to be eaten raw that shortens the smoking and curing time.

U.S. Pat. No. 4,016,292 to Hood (incorporated herein by reference) teaches a process for improving the color stability of fresh meat by administering a massive dose of ascorbate through the vascular system of the animal.

U.S. Pat. No. 5,464,638 (incorporated herein by reference) to Kakolewski teaches perfusion-aided meat processing for tenderizing and flavoring meat.

Mazzi Injector Corporation teaches methods to entrain gases in liquids by differential pressure, gas mixers, and other methods on catalogue pages 1, 8, 22, and 28 (incorporated herein by reference).

Extensive research has been done in the areas of oxygen deprivation, or hypoxia, experiments and carbon monoxide poisoning experiments utilizing carbon monoxide as a tool to study respiratory physiology of fish and other animals.

George F. Holeton of the Department of Zoology at the University of Bristol reports on the behavior of trout exposed to low concentrations of carbon monoxide in “Oxygen uptake and transport by the rainbow trout during exposure to carbon monoxide”, Journal of Experimental Biology, 1971 (incorporated herein by reference).

Fisher, Coburn, and Forster of the School of Medicine at the University of Pennsylvania report on the carbon monoxide uptake and CO blood capacity of catfish in “Carbon monoxide diffusing capacity in the bullhead catfish”, Journal of Applied Physiology, Vol. 26, No. 2, February 1969 (incorporated herein by reference).

Jensen, Nikinmaa and Weber discuss the characteristics of hypoxia in “Environmental perturbations of oxygen transport in teleost fishes: causes, consequences and compensations,” chapter six of Fish Ecophysiology, Chapman & Hall, 1993 (incorporated herein by reference).

Typically in this research on fish, carbon monoxide is dissolved in water solution and is taken into the blood of the fish through the gills. However, Holeton believes that since an increased oxygen affinity of the remaining hemoglobin in the blood is increased in the presence of carbon monoxide (Stadie & Martin, 1925), the amount of oxygen and/or carbon monoxide that releases from the blood and is transported to the tissue is likely to be very little. Fisher, Coburn, and Forster state that the total carbon monoxide capacity in catfish is calculated based on the CO saturation of the blood hemoglobin alone, and do not consider any transfer of CO to the tissue. Until the current invention, research has focused on gas exchange into the blood hemoglobin. The ability to control CO concentrations in the tissue myoglobin, and as a result the color, through blood hemoglobin circulation was unexpected.

None of the inventions and disclosures to date teach a method to kill, or nearly kill, and treat the tissue of whole fish with tasteless smoke, carbon monoxide, or gas through the respiratory and circulatory systems without invasive procedures.

Natural baseline carbon monoxide levels have been measured in seawater, lake water, and in the tissue of various species of fish. In fresh and salt water, much of the CO is produced by photochemical reactions, has a half-life on the order of hours, and is rapidly released into the atmosphere. Pos et al, Marine Chemistry, 62:89-101, 1998, measure the CO production rate of Biscayne Bay, Florida at 28.1 nM/liter/hr. Zuo and Jones, Water Research, 31(4):850-858, 1997, measure CO production rates varying from 36 to 490 nM/liter/hr for several fresh water locations; and Zuo, Guerrero, and Jones, Chemistry and Ecology, 14:241-257, 1998, report a global ocean surface average production of 10 nM/liter/hr.

Conrad et al, Limnology and Oceanography, 28(1):42-49, 1983 report CO concentration of 40 to 130 nl CO/liter of lake water. Relating the Zuo data and the Conrad data allows translation of CO production rates to CO concentrations. Such CO concentrations average 80 nl CO/liter of lake water, 10 nl CO/liter of coastal sea water, and 4 nl CO/liter of open ocean sea water.

Ishiwata et al, Journal of the Food Hygenic Society of Japan, 37(2): 83-90, 1996 found basal CO in commercial fish of 3 to 265 micrograms per kilogram of fish with white flesh fish at the low end of the range and red flesh fish at the high end with the exception of tilapia.

Optimal utilization of fish respiratory and circulatory systems for carbon monoxide treatment of tissue above the natural level requires a thorough understanding of the vascular transport and gaseous exchange characteristics and parameters of fish physiology. Jobling describes these characteristics and parameters in chapter four of Environmental Biology of Fish, Chapman & Hall, 1995 (incorporated herein by reference). Specifically, these elements are the cardiac output of blood transported through the fish; the gas solubility of the treatment gas in a respirable solution; the ventilation of gases at the gills; the uptake and binding capacity of carbon monoxide by the hemoglobin of the blood; and the transfer of the carbon monoxide to the myoglobin of the tissue. Treatment of fish tissue occurs when the level of carboxymyoglobin exceeds the natural level for any species.

Cardiac output. The heart pumps blood through the fish circulatory system with the cycle time proportional to the size and type of the fish. Cardiac output, or the volume of blood pumped per unit time, for fish range from 10 to 100 ml per minute per kilogram. Warm water species with high metabolisms such as thunnids (tunas), scombrids and pelagics range from approximately 60 to 100 ml per minute per kilogram; salmonids, snappers and other intermediate species range from 30 to 80 ml per minute per kilogram, and more sluggish species such as cod range from 10 to 50 ml per minute per kilogram.

Cardiac output also varies with size, with smaller fish generally having higher cardiac outputs than larger fish. This explains why circulation times, i.e. the blood volume divided by the cardiac output, are not constant across a species. It is typically faster for smaller fish than for bigger fish due to the length and breadth of the larger fish's circulatory system.

Warm water species generally have high metabolic and high heart rates requiring rapid diffusion of O₂ to the myocardium. Most fish have resting heart rates in the 30 to 60 beats per minute (bpm) range with a maximum only 20 to 30% higher. However, unlike other species, thunnids have high cardiac output levels and a well-developed separate coronary circulation system resulting in a resting heart rate of 40 to 120 and a maximum heart rate of 250 to 260 bpm.

Hypoxic conditions and out of water conditions (cessation of water flow over the gills) have considerable impact on the cardiac output of fish. Holeton reports, and it is confirmed by Jensen, Nikinmaa and Weber, that the heart rate and ventral and dorsal aortic blood pressure speed up considerably during hypoxic conditions to as much as 130% to 170% of normal. Furthermore, the gill irrigation rate increases by as much as 228% to 412% of normal. The fish start swimming faster and ventilate at a higher rate to extract more O₂ from the water. The heart beats faster to spread the scarce supply of O₂ in the blood to the muscle tissue. The current invention uses this natural characteristic to accelerate the flow of carbon monoxide from the water to the blood to the tissue. FIG. 1 from Holeton shows the effect of a 30 minute exposure of 5% CO concentration on the heart rate of rainbow trout.

Conversely, out of water conditions show decreases in heart and metabolic rates to 12% to 50% of normal as the fish conserve energy in an attempt to survive until they are back in a water environment where they can breathe. Keen, Aota, Brill, Farrell, and Randall report on this characteristic in “Cholinergic and adrenergic regulation of heart rate and ventral aortic pressure in two species of tropical tunas, Katsuwonus pelamis and Thunnus albacares,” Canadian Journal of Zoology, 73: 1681-1688, 1995 (incorporated herein by reference). FIG. 2 from Keen et al shows the change in heart rate from 60 to 80 bpm to 10 to 20 bpm in a skipjack tuna in response to a cessation of water flow over the gills.

These characteristics impacting the cardiac output of fish are considered and utilized in the present invention.

Brill, Cousins, Jones, Bushnell and Steffensen measure blood circulation times of yellowfin tuna in “Blood volume, plasma volume, and circulation time in high energy demand teleost, the yellowfin tuna,” published Feb. 5, 1998 on the World Wide Web. This is consistent with the following cardiorespiratory function statistics that have been presented for tunas and other teleosts by a variety of researchers:

TABLE I

| | Yellowfin | Skipjack | | Rainbow |
|---|---|---|---|---|
| | Tuna | tuna | Yellowtail | trout |
| Temperature | 25 C. | 25 C. | 19-25 C. | 10 C. |
| Body mass (kg) | 1-2 | 1-2 | 1 | 0.9-1.5 |
| Activity level | routine | routine | rest | rest |
| | | | | to max |
| Blood volume (ml/kg) | 31-54 | 50 | 46 | 35-52 |
| Cardiac Output | 115 | 132 | 35 | 18-53 |
| (ml/min/kg) | | | | |
| Circulation Time | .27-.47 | .38 | 1.3 | 1.0-1.9 |
| (min) (1) | | | | |
| Ventilation volume | 2.4-4.7 | 3.8 | 0.46 | 0.5-1.7 |
| (liter/min/kg) | | | | |
| Hematocrit (%) | 27-35 | 34-38 | 29 | 23-27 |
| Hemoglobin concentra- | 11-12 | 13 | 11 | 6.4 |
| tion of blood (g/deciliter) | | | | |
| Mean cell Hemoglobin | 31-44 | 34-38 | 38 | 29 |
| concentration (g/dl) | | | | |

(1) Circulation is faster for smaller fish within a given species that have higher cardiac output rates.

Data for the above chart for yellowfin and skipjack tunas compiled from Muir and Hughes (1969), Bushnell et al (1988, 1990), Jones et al. (1986, 1990, 1993), Brill and Bushnell (1991), Dewar et al (1993, 1994), Brill and Jones (1994), Korsmeyer et al (1997), Brill et al (1998), and Lowe et al (1998). Data for yellowtail compiled from Yamamoto et al (1981), Itazawa et al (1983), and Ishimatsu et al (1990, 1997). Data from rainbow trout compiled from Holeton and Randall (1967), Randall et al (1967), Kiceniuk and Jones (1977), Gngerich et al (1987, 1990, Tetens and Christensen (1987), Palzenberger and Pohola (1992), and Farrell and Jones (1992).

Gas solubility. The solutes oxygen (O₂) and carbon monoxide (CO) have similar absorption and solubility coefficients in the solvent water (H₂O) with O₂ slightly more soluble. The volume of gas, vo, (in milliliters STPD) dissolved in one liter of water at one atmosphere pressure (760 mm Hg) is expressed by the following formula:

vo=absorption coefficient×(V×Po)

where V is the volume of the solvent, and Po is the partial pressure of the gas in atmospheres. Therefore, the amount of gas dissolved is dependent upon its partial pressure in a linear relationship.

The coefficient of solubility is defined as the volume of the gas taken up by a unit volume of the solvent under a particular set of temperature and pressure conditions. If v is the volume of the dissolved gas, measured at temperature T and partial pressure Pg atm, with To equal to 0 degrees Centigrade, then:

Vo=(v×Pg×To)/T

Which shows that the solubility of a specific gas will decrease as temperature increases. Furthermore, solubility of atmospheric gases is lower in seawater than in fresh water. The difference in oxygen solubility between the two media is approximately 20%.

For example, at a specific temperature of 24 degrees Centigrade, one atmosphere of pressure, and a 20% reduction in solubility due to a seawater medium for salt-water fish, O₂ and CO maximum solubility will be:

18.24 ml O₂per liter H₂O

17.63 ml CO per liter H₂O

The solubility constant for H₂O is 0.030 ml O₂/liter H2O/mm1Hg O₂ and the solubility constant for CO is 0.029 mlCO/liter H₂O/mmHgCO. These constants are used to compute the amounts of each gas that can be dissolved in liquid water or blood plasma for a given partial pressure of O₂ or CO.

Ventilation of gases at the ills. Respiration is the sum of the processes by which the respiratory gases oxygen and carbon dioxide pass from the environment to the blood and vice versa. The present invention uses these processes to transport CO to the tissue of the fish.

Compared with air, which contains 200 ml O₂ per liter, the oxygen content of water is very low as shown in the example above. Fish have active gill ventilation across the gill lamellae with the essential feature being the counter current exchange system of flows of water and blood in opposite directions to most efficiently transfer gases between the two media. As a result the absorption of CO in fish occurs almost exclusively through the gills from the ventilated water.

The primary factor of maintaining this extraction efficiency is lamellar recruitment. In a resting fish, only about 60% of the secondary lamellae are perfused with blood, but as the fish becomes more active, more of the gill lamellae are recruited and supplied with blood.

According to Holeton, the more CO is taken into the blood at the gills and the more O₂ is restricted, then the more the fish will work to find and deliver O₂. The gills become more perfused with blood during low O₂ hypoxic conditions, or CO displacing O₂ conditions.

When the fish is caught and taken out of water, the gills lose this water flow and the rate of perfusion of the lamellae declines. Restoration of water flow quickly reverses this slowdown of blood perfusion and accelerates transfer of gases. Cooke and Philipp report on the behavior of fish taken out of water and placed back in water in “Influence of terminal tackle injury, handling time, and cardiac disturbance of rock bass,” North American Journal of Fisheries Management, 21:333-342, 2001.

Uptake and binding capacity of the hemoglobin in the blood. The oxygen and carbon monoxide carrying capacity of the blood is proportional to the presence of the respiratory pigment, hemoglobin, contained within red blood cells. Hemoglobin is a metalloporphyrin combining an iron porphyrin with globin, a protein.

The ferrous iron atom in each heme can bind to one molecule of oxygen or carbon monoxide. The hemoglobins are tetrameric with four receptors, so each hemoglobin can bind with four molecules of O₂ or CO. FIG. 3 shows the heme-CO relationship at one binding site in the hemoglobin molecule.

The hemoglobin is contained within the red blood cells and there may be a four to fivefold difference in volume of red blood cells possessed by different fish species. In addition to red cell volume, the percentage of the red cells in the blood also shows considerable variation.

The hematocrit (Hct) is the percentage of red blood cell volume of the total blood volume. At one end of the spectrum lies the icefish, Chaenocephalus aceratus, with very few, hemoglobin-free, red blood cells. At the other end are the thunnids and scombrids, with hematocrits of 30 to 50%. The majority of fish are within the 15 to 30% range.

Blood volume, as a percentage of the body, and hemoglobin contents tend to be inversely correlated. Fish with large blood volumes of 10% or more tend to have a low hematocrit and a low hemoglobin content, compared with those species having a more normal blood volume of 3 to 6%.

This blood transport of O₂ or CO temporarily bound to the hemoglobin (“Hb”) is much more efficient than free solutions of these gases in the blood plasma. The amount of each that can be carried in solution is about 0.5 to 0.9 ml per 100 ml of blood, but with hemoglobin present, fish bloods carry 5 to 16 ml oxygen per 100 ml and even greater levels of carbon monoxide due to much higher binding affinity with the latter.

In the majority of fish species, the presence of hemoglobin in the blood leads to the capacitance coefficient of the blood being much higher than that of the water, so that gas exchange is optimized when gill ventilation volume is approximately 10 to 20 times the cardiac output.

Carbon monoxide has a binding affinity for hemoglobin of approximately 66 to 240 times that of oxygen. The carbon monoxide or oxygen affinity for hemoglobin is conventionally determined as the partial pressure (P50) of CO or O₂ at which half the hemoglobin is saturated with, or bound to CO or O₂. FIG. 3 shows saturation curves of hemoglobin as a function of the partial pressure of CO or O₂. The P50 level on each curve is a measurement of the carbon monoxide or oxygen affinity for hemoglobin.

Hemoglobin CO capacity is 1.39 multiplied times the hemoglobin concentration in the blood which gives ml of CO per gram of Hb per deciliter of blood. For example, from the cardiorespiratory table above the hemoglobin concentration of yellowfin tuna is 11-12 grams/deciliter and when multiplied by 1.39 the result is 15.3-16.7 ml CO/deciliter of blood as the COHb capacity of yellowfin.

The arterial saturation of hemoglobin in the blood with oxygen normally ranges from 92 to 98% O₂Hb with approximately 75% to 80% of the oxygen in the inspired water removed during ventilation. However, the maximum saturation of COHb can range from 94% in Holeton's research to 100% maximum with 90% to 100% of the carbon monoxide in the inspired water removed during ventilation due to the much stronger binding affinity. Prior to the introduction of CO, the Hb in the blood would alternately become oxygenated and then deoxygenated through the blood circulation cycle. After introduction, the carbon monoxide behaves similarly to oxygen and takes precedence in binding to the hemoglobin receptors.

The uptake of the CO by the Hb in the blood will be exponential to start due to the increasing heart and metabolic rates brought on by the low blood oxygen content conditions. However, there will ultimately be an inflection point where the rate of uptake slows due to the decreasing number of open receptors. Therefore, the CO uptake curve will typically be sigmoid—a combination of early exponential and later asymptotic behavior.

Transfer of the carbon monoxide to the myoglobin (“Mb”) of the tissue. The hemoglobin receptors act as carriers of the COHb through the blood arterial and capillary systems to the intercellular fluid surrounding the myoglobin cells of the tissue. At equilibrium, the human body shows a ratio of 5.3:1 between COHb in the blood and COMb in the tissue. We estimate that all optimally treated tuna will have a ratio of COHb to COMb averaging 9.9:1 with a range of 5:1 to 153:1; optimally treated yellowfin tuna will have a ratio of 18.7:1 with a range of 11:1 to 68:1; and optimally treated tilapia will have a ratio of 19.0:1 with a range of 11:1 to 67:1. The ratio COHb in the blood to COMb in the tissue is surprisingly similar across a variety of fin fish species beyond just tuna and tilapia.

The binding affinity of myoglobin is greater than the binding affinity of hemoglobin with both being much greater than the solubility of the blood plasma. In the exchange process, the CO molecule has to first release from the Hb, then flow into the intercellular fluid and finally on to the single receptor of the Mb molecule. In this case, the Mb receptors behave asymptotically and the myoglobin treatment slows as more and more COMb is formed in the cells. Maximum saturation is maximum treatment of the seafood and may be more than desired.

Minimum saturation of the fish is defined as the amount of treatment that occurs when tasteless smoke or CO above basal levels is introduced; the fish ventilates CO from the water at greater than basal levels, the blood volume of the fish passes one time through the lamellae structure of the gills; a COHb saturation above natural levels is achieved; the blood passes through the arterial system and the capillary system to bring the heightened COHb saturation to the tissue; some CO releases into the intercellular fluid of the tissue; and CO above normal levels is bound to the myoglobin of the tissue.

This minimum saturation can occur in one half cycle of the circulatory system. For example, the circulation time for the one kilogram yellowfin tuna listed above is 0.27 to 0.47 minutes. Therefore, minimum treatment for the smaller of this species throughout the tissue can be expected in 0.14 to 0.24 minutes, or 8 to 14 seconds. For larger fish, the half cycle of circulation time will be longer and inversely proportional to their reduced cardiac output rate.

Maximum saturation time is a function of the gill absorption rate and reaching saturation equilibrium within the fish blood and the fish tissue. This absorption rate has two components, the CO bound to the Hb and the free CO diffused through the gills directly into the blood plasma. It can be computed by the following relationship:

CO gill absorption=(cardiac output*(Hb*1.39*%sat)*wt)+((cardiac output*(0.029*PCO)/100)*wt)

Cardiac output is in ml blood/min/kg; Hb is blood hemoglobin in grams/ml (Hb is divided by 100 to convert dl to ml; wt is fish weight in kg; 0.0029 is the solubility of CO in mlCO/dl; PCO is the partial pressure of CO in mmHg (0.0029*PCO) is divided by 100 to convert dl to ml.

From the cardiorespiratory function table above, we assume a yellowfin tuna with wt=1 kg; Hb=0.11 gm/ml; cardiac output=115 ml/min/kg; %sat=100%; and PCO=228 mmHg which is the partial pressure of tasteless smoke comprised of 30% CO.

CO gill absorption=(115*(0.11*1.39*100%)*1)+((115*(0.0029*228)/100)*1)=17.58+0.76 mlCO/min=18.34 mlCO/min

or assuming constant parameters with the exception of weight, then CO gill absorption/kg=18.34 mlCO/min/kg

The first time blood flows through the gills at this heightened CO level, the CO absorption rate will be at its maximum. After the blood has completed a circuit the absorption rate will decrease exponentially over time with each circuit until the CO in the tissues reach equilibrium with the CO in the blood. With yellowfin tuna this will occur very rapidly at a full concentration of tasteless smoke of 30% CO since the complete circuit time for small fish is 0.27 to 0.47 minutes, and for larger fish it is slightly longer.

Therefore, the time required for CO in the blood and in the tissue to reach equilibrium is a function of cardiac output, circulatory circuit transit time, blood volume and body size. Typically, the larger the fish, the greater the circulatory transit time. Blood volume is also greater in larger fish. The cardiac output varies with hypoxic and water flow cessation conditions. As a result it is difficult to calculate the exact time equilibration will be achieved. However, fish behavior can be used to estimate necessary exposure times. The loss of coordinated activity is a good sign of initial absorption to above 90% Hb saturation.

### DISCLOSURE OF INVENTION

The present invention relates to a novel method to treat meat of animals by introduction of a treatment medium through the respiratory and circulatory systems of the organism. The example set forth illustrates the introduction of tasteless smoke (as described in U.S. Pat. No. 5,972,401) or carbon monoxide into meat through the respiratory and circulatory systems of fish. However, variations of the art would include other elements that can be suspended in fluids that would effect a treatment when passed through the respiratory and circulatory systems of animals. Further variations of the art would include treatment elements suspended in fluids or plasma, which are artificially introduced and pumped through the blood streams of animals bypassing their respiratory and circulatory systems.

The Kowalski ‘401’ patent's tasteless smoke is a preferred treatment ingredient because meat (including fish and other seafood) treated with tasteless smoke will, after being frozen and thawed, detectably spoil over time, so that consumers will be able to detect whether tasteless smoked meats are safe to eat. However alternatives to tasteless smoke include, but are not limited to, pure carbon monoxide, nitrogen compounds, other gases, minerals such as salt, and enzymes. In addition, partial filtering steps of smoke of the Kowalski ‘401’ patent can be used in this invention in conjunction with further filtering and purifying that occurs when partially purified smoke passes through water and the membranes of whole fish.

The procedure is preferably conducted while the animal is alive, or alternatively can be conducted after the animal is dead. To demonstrate the subject of this invention the treatment of live fish through their respiratory and circulatory systems is used. However the principles of treatment elements flowing through the circulatory system and treating the animal's meat from the inside out apply whether the treatment element flows through the natural respiratory and circulatory system of a live animal or is artificially respired and pumped through a recently killed animal. Specific dosages of carbon monoxide can be dissolved in liquids or blood and injected into live animals.

This invention practices two different primary variations utilizing the natural physiology of the respiratory and circulatory systems of the fish to achieve the desired preservative treatment effects. The first method is to treat fish that can be contained, such as live fanned fish, in a tank with a solution of dissolved or entrained tasteless smoke or carbon monoxide at a given temperature at one atmosphere pressure in salt or fresh water. The second method is to treat captured wild fish with a foam colloid with the tasteless smoke or carbon monoxide entrained in the foam.

Both methods can be viewed as analogous to the principles and components of photography where the tasteless smoke or carbon monoxide can be viewed as the light. It is the medium that ultimately will treat the meat of the fish just as the light exposes the film. The tasteless smoke or CO concentration in water or the foam colloid can be viewed as the aperture. It limits the amount of CO that can enter the fish per unit time just as the aperture controls the rate at which light passes through the lens. Lastly, the treatment time of exposure can be viewed as the shutter speed. It determines the total time that the dissolved or entrained tasteless smoke or CO is in contact with the fish and passes through to its tissue just as the shutter speed controls the time of exposure of the film.

Therefore, under the tank treatment method, two primary variables or “dials” can be varied to control the level of desired treatment—the tasteless smoke or CO concentration dissolved in the water and the time of treatment. Any concentration level of carbon monoxide above the level found in the natural habitat for the species will result in treatment of CO in the tissue above the natural level.

The Zuo and Conrad data show baseline natural levels of CO concentrations averaging 80 nl CO/liter of lake water, 10 nl CO/liter of coastal sea water, and 4 nl CO/liter of open ocean sea water. Using this concentration of 10 nl CO/liter seawater, a CO P50 of 0.4 mmHg, and a CO solubility of 0.029 mlCO/liter, then a 0.043% COHb saturation of the blood is estimated. Fisher, Coburn and Forster report that fresh water catfish had a natural COHb saturation of 6.1%. Fresh water lake fish would be expected to have 8 to 20 times the COHb saturation of ocean fish and catfish would have one of the highest natural levels.

Although any CO concentration above these natural baseline levels will result in an increase in COHb saturation of the blood and a corresponding increase in COMb saturation in the flesh, slight concentration increases will take days or weeks to treat the fish. Therefore, we assume a minimum dial “aperture” concentration of 0.008 ml/liter which is 1,000 times stronger than natural conditions, and a maximum concentration of full saturation CO dissolved in water of 17.63 ml/liter for treatment.

Under the tank treatment method the optimal ventilation rate of 10 to 20 times is utilized, and the level of treatment and resultant COMb in the tissue can be controlled by varying the concentration and the time of treatment which will range from one second to several days. CO concentrations can be measured in the water, the blood, and the meat to determine the optimal combination of the two control variables for the desired treatment for a given species.

This method can be used to treat fish with COHb concentrations ranging from less than 5% to over 95% COHb. Empirical observation has shown that certain species of fish have an unexpected ability to endure high dosages of carbon monoxide for extended periods of time.

For example, tilapias were placed in a treatment tank with tasteless smoke (30% carbon monoxide) bubbled vigorously throughout the water volume for at least five minutes which corresponds to the five to six minutes of bubbling time of the Holeton research.

The clearance time for the tasteless smoke saturated water supply to return to a CO free solution was the same. This provided for a controlled tasteless smoke water exposure system.

Within approximately 1.5 to 3 minutes the fish rose to the water surface looking for clean water to respirate and increased their swimming activity through tasteless smoke bubbles. The fish flesh obtained a very light toning treatment effect that is more apparent after freezing and defrosting.

Within approximately 3 to 5 minutes the ventilation of the fish increased, they became more active, and they became disoriented, bumping into the walls of the tank. The fish flesh obtained a light treatment effect.

Within approximately 4 to 7 minutes the scales changed from black to a reddish-gray and the lip color changed to a blood red. The fish flesh obtained a light to medium treatment effect.

Within approximately 6 to 9 minutes fish activity began to slow down and the fish started to float sideways. The fish flesh obtained a medium treatment effect.

Within approximately 8 to 11 minutes activity is minimal. The fish flesh obtained a medium to high treatment effect.

Within 10 to 15 minutes the fish is not moving at all except for slight movement of the gills. The fish flesh obtained a high treatment effect.

Within 45 minutes to one hour some fish can be resuscitated by relocating them to respirable water. The fish flesh obtained a maximum treatment effect. However, the treatment intensity after recovery declined over time if the fish remains in respirable water and the flow of CO reverses from the flesh to the blood and back in to the water.

It is estimated that 90% COHb was reached in the maximum treated fish. However, substantial recovery was observed in less than 10 minutes after being relocated to clean respirable water. Humans experience rapid death when COHb levels exceed 80% and the half-life (time it takes for a 50% COHb reduction in the blood) is 5 hours. For fish, the diffusion into and out of the blood is much faster.

Certain species of fish demonstrate this ability to remain alive for long periods after treatment with heart activity still remaining. Therefore, the final killing and bleeding can be completed using the circulatory function to eliminate the blood as well as treating and preserving the meat.

Further, various treatment effects can be employed by harvesting the fish during the COHb up loading or down loading cycle. For example, if the COHb is up loaded and the fish are harvested, CO in the Hb may continue to diffuse into the myoglobin after harvesting until equilibrium is reached. However, if a fish with high COHb is placed in suitable water, then COHb will rapidly decrease, thereby producing a completely different treatment effect.

Tasteless smoke or carbon monoxide dissolved or entrained in water, can be applied in either a treatment tank or by flowing water over the gills.

Under the second method, a foam colloid is generated by bubbling CO through an egg white and water medium and applying it to the mouth and gills of the fish. The chance of a carbon monoxide molecule striking a hemoglobin molecule in this method is very high due to the high concentration of the CO gas in the foam colloid coating the lamellae structure of the gills and filling the opercular and buccal cavities of the fish. While the fish cannot function without water indefinitely, some biological functioning of the respiratory and circulatory systems can continue for three minutes to twenty minutes or longer after the fish is removed from the water.

The foam colloid solution containing tasteless smoke or carbon monoxide can be applied to the gills and opercular and buccal cavities of the fish for an exposure time ranging from 10 seconds to 30 minutes, or as long as necessary to achieve the desired treatment effect. The foam is then rinsed with water clearing the area of the treatment medium and slightly resuscitating the fish in order that it can better circulate the COHb throughout its circulatory system to the tissue.

The present invention of carbon monoxide transport into the myoglobin through the respiratory and circulatory system is a superior process to regulate the percentage of total myoglobin bound to carbon monoxide with capability to replicate natural coloration and subsequent discoloration.

The COHb saturation can be controlled by regulating the carbon monoxide concentration in the water or solvent, and knowing the rate of ventilation. Concentration of carbon monoxide in the solvent, the ventilation volume and exposure time vary according to the metabolism of the fish during treatment.

According to Ishiwata and other researchers, the natural flesh of fresh fish contains concentrations of carbon monoxide ranging from 3 to 265 micrograms per kilogram with relatively narrow ranges for most species. However, the range will be much greater for those species such as tuna, which naturally exhibit a significant variance in the redness of the flesh. In general, the more red the flesh the greater its carbon monoxide binding capacity due to its higher concentration of carbon monoxide sensitive myoglobin. Consequently, red-flesh will score high in carbon monoxide concentration range and white-flesh fish will be in the low range.

For example, the carbon monoxide concentration of natural yellowfin and big eye tuna flesh will range from approximately 20 μg/kg to 240 μg/kg, with the majority of yellowfin and big eye tunas ranging from approximately 40 to 100 μg/kg. Carbon monoxide concentration of natural tilapia flesh will range from approximately 6 μg/kg to 15 μg/kg, averaging approximately 7 to 10 μg/kg.

However, when natural fish flesh or other meats are treated with carbon monoxide the concentrations in the flesh can increase incrementally from approximately 1.1 to 20 times and on occasion to as much as 80 times. These observed and measured increases in carbon monoxide in the flesh are dependent upon several factors including the quantity of myoglobin in the fish and other meats, carbon monoxide concentration, time, and method of exposure.

Carbon monoxide concentration in animal tissue can be minimized to between approximately 1.1 to 3.99 times the natural carbon monoxide concentration in animal flesh, optimized to between approximately 4 to 9.99 times the normal carbon monoxide concentration in animal flesh, or saturated to between approximately 10 to 20 times the normal carbon monoxide in animal flesh.

The level of micrograms/kilogram in tasteless smoke and carbon monoxide treated fish has been studied for several years for external exposure and injection treated product. The volume of CO in ml per kilogram can be calculated by taking the Ideal Gas constant of 22.414×the number of millimoles=(number of micrograms/28)/1000. The resultant conversion factor is 0.000805×micrograms/kilogram ml CO/kg. The following chart shows empirically measured minimal, optimal, and saturation levels of CO treatment levels in the tissue along with the estimated corresponding CO equilibrium level in the blood:

TABLE II

| | | | | water |
|---|---|---|---|---|
| | | | | minimum |
| | tissue | tissue | blood | ml CO/ |
| | μg CO/kg | ml CO/kg | ml CO/kg | liter H₂O |
| Minimal | | | | |
| treatment: | | | | |
| All tuna | 22 to 957 | .018 to .766 | 2.07 to 4.94 | .092 |
| Majority | 44 to 399 | .035 to .319 | 2.07 to 3.99 | .092 |
| yellowfin | | | | |
| and big | | | | |
| eye | | | | |
| Tilapia | 6.6 to 60 | .005 to .048 | .18 to .86 | .008 |
| Majority | 7.7 to 40 | .006 to .032 | .18 to .53 | .008 |
| of tilapia | | | | |
| Optimal | | | | |
| treatment: | | | | |
| All tuna | 80 to 2,397 | .064 to 1.919 | 7.34 to 12.36 | .882 |
| Majority | 160 to 399 | .128 to .800 | 7.34 to 9.97 | .882 |
| yellowfin | | | | |
| and big | | | | |
| eye | | | | |
| Tilapia | 2.4 to 150 | .019 to .120 | .44 to 2.10 | .176 |
| Majority | 2.8 to 100 | .022 to .080 | .44 to 1.31 | .176 |
| of tilapia | | | | |
| Saturation | | | | |
| treatment: | | | | |
| All tuna | 200 to 4,800 | .160 to 3.842 | 18.34 to 24.72 | 2.646 |
| Majority | 400 to 2,000 | .320 to 1.601 | 18.34 to 19.94 | 2.646 |
| yellowfin | | | | |
| and big | | | | |
| eye | | | | |
| Tilapia | 60 to 1,200 | .048 to .961 | 3.20 to 15.13 | 1.408 |
| Majority | 70 to 200 | .056 to .160 | 3.20 to 9.41 | 1.408 |
| of tilapia | | | | |

Tasteless smoke and carbon monoxide treatment act to prevent discoloration of the meat flesh that is held at conventional −20 degrees Fahrenheit cold storage temperatures and subsequently defrosted. If the meat is saturated with carbon monoxide to its maximum binding capacity, then the color and subsequent discoloration may appear unnatural.

Carbon monoxide transport into the myoglobin through the respiratory and circulatory system is a superior process to regulate the percentage of total myoglobin bound to carbon monoxide with the capability to replicate natural coloration and subsequent discoloration. Utilizing the preferred medium of tasteless smoke with its 30% concentration of CO and other component gases with preservative effects, produces more natural treatment results as the naturally lower CO partial pressure increases the time to reach equilibrium saturation and helps to prevent over saturation.

Regulating blood COHb can control the intensity of the treatment effect and the carbon monoxide content in the flesh. Carbon monoxide concentration in the inspired water or solvent and the gill absorption rate during ventilation determines the COHb production and free CO in the blood plasma. However, due to the high binding affinity and low P50 partial pressure of 0.4 mmHg for carbon monoxide, all available hemoglobin receptors passing over the gills will bind CO molecules from the inspired water at very low concentrations. Exposure time and cardiac output determines the volume and rate by which COHb is bound and transported through the body. However, equilibrium between the COHb and COMb, CO elimination, respiration through other organs, and other factors will influence the COHb saturation as well.

For example, a 10-kilogram tuna with a cardiac output of 115 ml/min/kg and a total blood volume of 43 ml/kg treated for 30 seconds with 100% tasteless smoke (30% CO) in an H₂O solution will produce 91.75 ml of CO according to the initial CO gill absorption formula, divided by 430 ml total blood volume equals 21.3% CO in the blood of the fish.

However, the cardiac output of a tuna can decrease to 12% of its resting state. Therefore, if a fish is treated by foam colloid solution while without water flowing over the gills, the cardiac output of a 10 kilo tuna could drop to as low as 13.8 ml/min/kg and a total blood volume of 43 ml/kg treated for 30 seconds will produce 11.01 ml of CO, divided by 430 ml total blood volume equals 2.6% CO in the blood of the fish.

Alternatively, if a 10 kilogram tuna swimming in water with a 100% CO solution of 17.63 ml CO per liter H₂O, a reduced cardiac output of 40 ml/min/kg and a total blood volume of 43 ml/kg is treated for 30 seconds, it will absorb 35 ml of CO into the blood, divided by 430 ml total blood volume equals 8.1% average CO in the blood of the fish. In this case, the cardiac output decrease to 40 ml/min/kg from 115 ml/min/kg noticeably slowed the uptake of CO by the blood despite the maximum CO concentration of the ventilated water.

By applying low concentrations of carbon monoxide to produce COHb and COMb at a slow rate, the quantity of CO μg/kg of flesh can be more precisely controlled. By applying higher concentrations of carbon monoxide to produce COHb and COMb at a faster rate for a shorter period of time, similar results can be achieved with a slight loss in precision control.

The carbon monoxide component of tasteless smoke is used to illustrate the preservative action of the process. However, preservative effects of other components of tasteless smoke will also be communicated through the natural systems of the fish.

Oxygen is less soluble in water than carbon monoxide and the binding affinity of carbon monoxide to hemoglobin and myoglobin are much stronger than oxygen. It is this natural affinity of carbon monoxide to hemoglobin and the novel method of introducing the carbon monoxide gas in a liquid solution form by diffusion through the respiratory system of a live fish to its muscle tissue that make the present invention unique.

The biological system of live fish provide an efficient means of transporting carbon monoxide throughout the fish. Carbon monoxide can be introduced into the blood stream by respiration and pumped by the heart through the arterial and capillary systems into every active tissue cell. Carbon monoxide compressed into capsules can be incorporated in animal feed and introduced into the body through the digestive system. Carbon monoxide suspended in liquids can penetrate through the epidermal surface of live fish. Lastly, carbon monoxide dissolved or entrained in blood plasma can be delivered through the circulatory system of a dead animal by a mechanical pump.

### BRIEF DESCRIPTION OF DRAWINGS

FIG. 1 is a graph of the heart rate of a rainbow trout during carbon monoxide exposure.

FIG. 2 shows the change in heart rate from 60 to 80 bpm to 10 to 20 bpm in a skipjack tuna in response to a cessation of water flow over the gills

FIG. 3 shows saturation curves of hemoglobin as a function of the partial pressure of CO or O₂.

FIG. 4 is a graph of Heme-Co relationship at one binding site in the hemoglobin molecule.

FIG. 5 is a perspective cutaway view of an apparatus for practicing the present invention.

FIG. 6 is a side view of the treatment basket being lowered into the treatment tank.

FIG. 7 is a side view of the treatment of fish using a cylinder of tasteless smoke.

FIG. 8 is a side view the hoist lifting the treatment basket containing the tasteless smoke treated fish.

FIG. 9 shows a device for creating a gas foam according to the present invention.

FIG. 10 shows the parts of a fish through which a gas foam according to the present invention is distributed.

FIG. 11 shows a gas exchange system for dissolving tasteless smoke into water, according to the present invention.

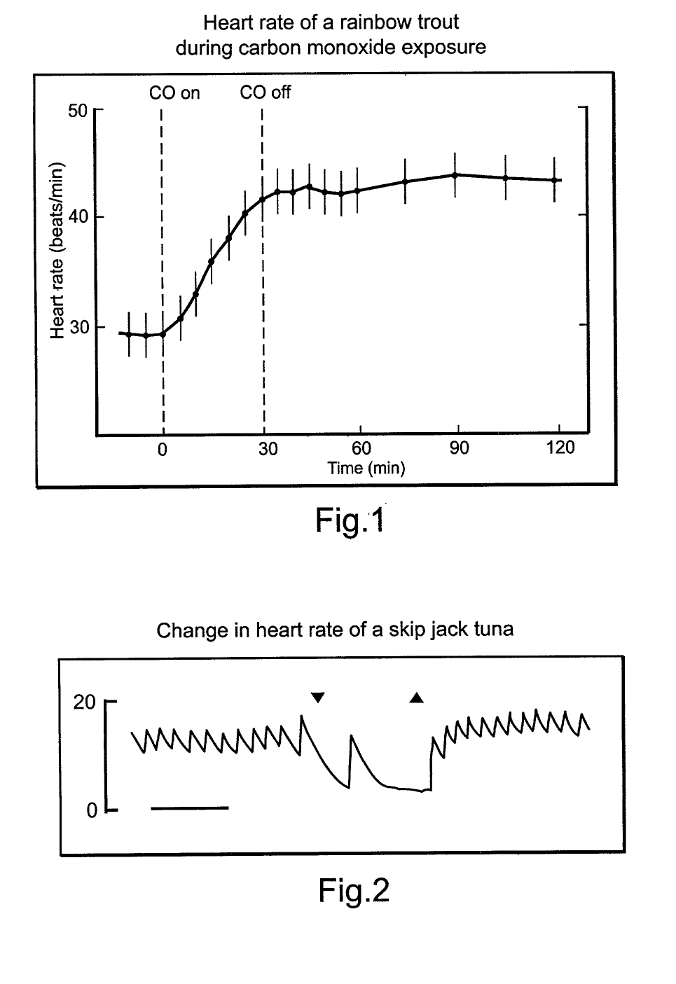

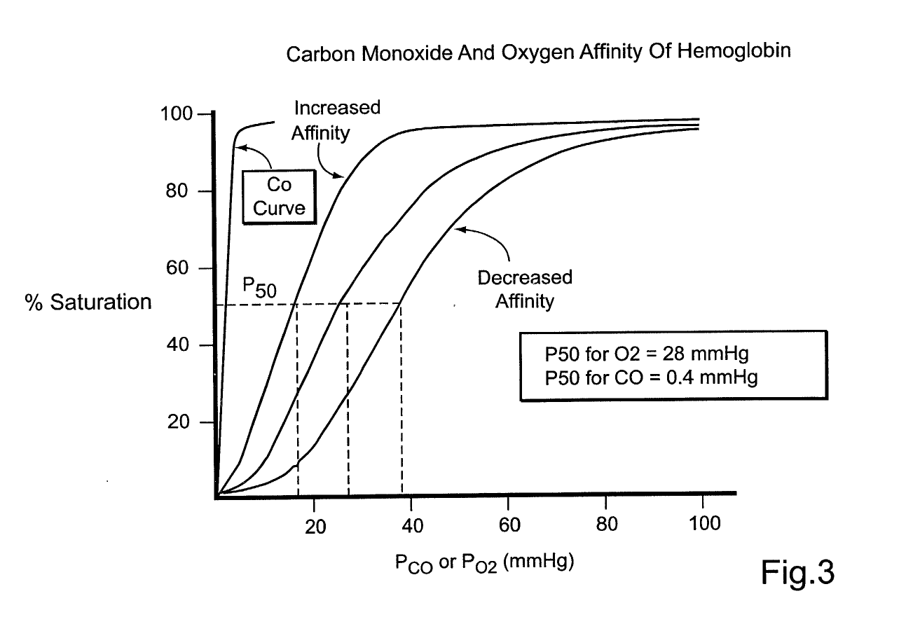

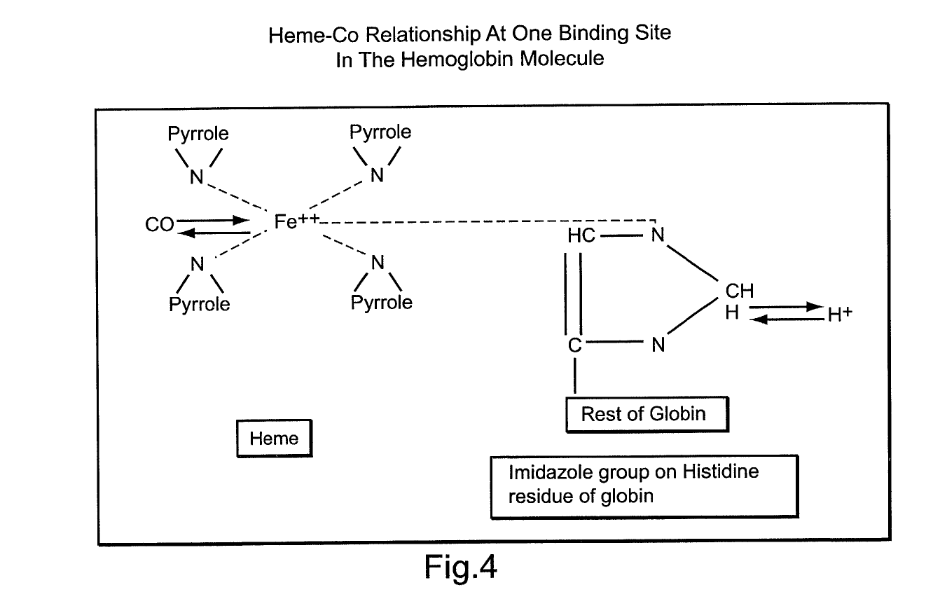

### BEST MODE OF PRACTICING THE INVENTION

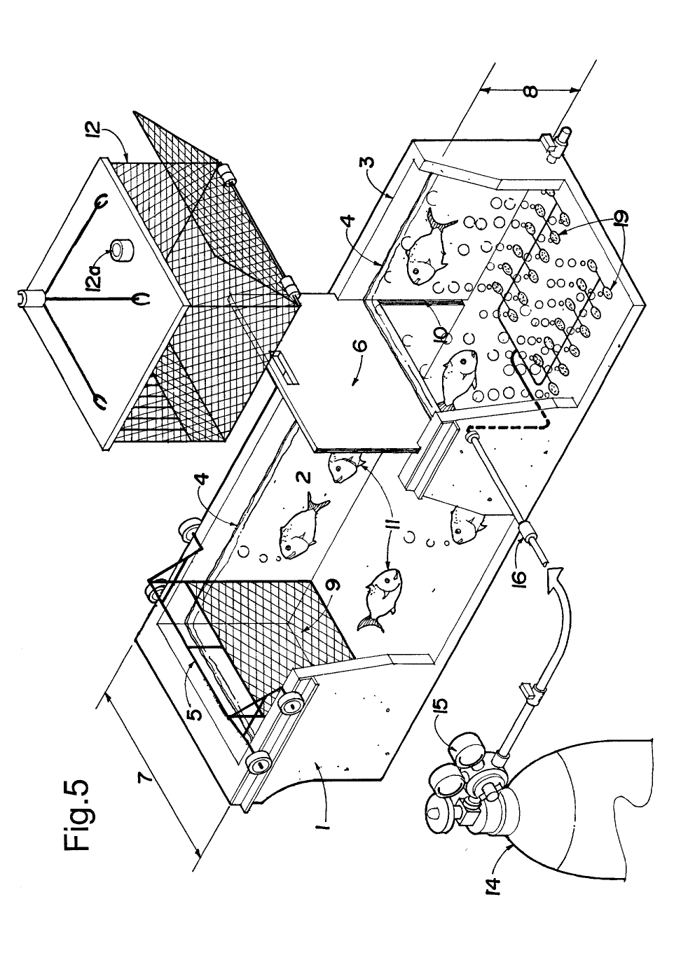

Referring to FIG. 5, a frame (1) containing a holding tank (2) and a treatment tank (3) is filled with water (4) that is biologically suitable to sustain the health condition of the fish to be treated. In the starting position, a sliding rake (5) is located at the far end of the holding tank (2) opposite the movable wall (6) with the treatment tank (3). The sliding rake (5) spans the width (7) and water depth (8) of the holding tank (2). The space tolerance between the rake (5) frame and the inside holding tank surfaces is less than the smallest dimension of the smallest fish, thus preventing its passage from one side of the rake to the other. The mesh size (9) of the rake (5) body is slightly less than the smallest dimension of the smallest fish also preventing its passage. The movable wall (6) is inserted into the slot (11) to separate the holding tank (2) from the treatment tank (3). Live fish (11) are provided in the holding tank (2) and staged for treatment.

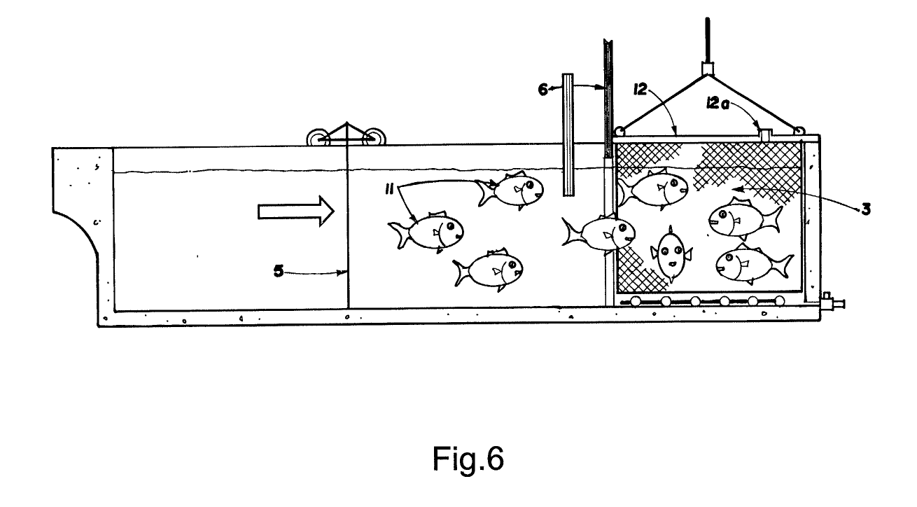

Referring to FIG. 6, a hoist lowers the treatment basket (12) into the treatment tank (3). The walls of the treatment basket (12) have a multiplicity of holes of a size to provide circulation of the water and treatment gas, plus rapid drainage, without allowing fish to pass through the basket's (12) walls. The movable wall (6) is lifted from the slot (10) thereby temporarily opening the holding tank (2) to the treatment tank (3) compartment.

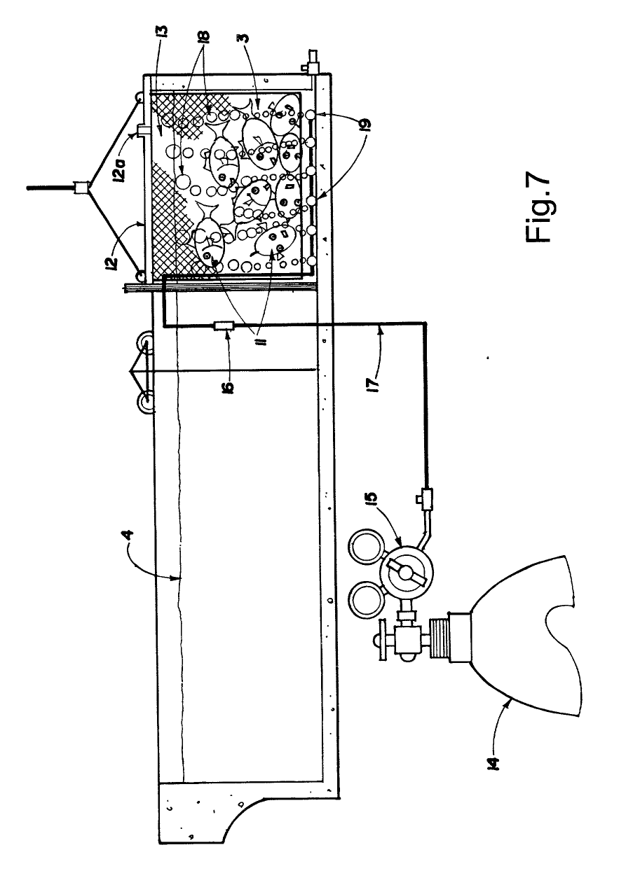

The sliding rake (5) is moved towards the treatment tank (3) “raking” the fish (11) into the treatment basket (12). Referring to FIG. 7, the movable wall (5) is lowered into the slot (10) containing the fish (11) within the treatment basket (12) in the treatment tank (3). A hood top of the treatment basket (12) covers the treatment tank (3) with an optional exhaust vent (12a) that can be attached to an exhaust fan and turned on for ventilation for safety. However, as long as the seal between the hood of the treatment basket (12) and the treatment tank (3) is airtight, then the tasteless smoke can accumulate in the headspace or ullage (13) providing additional treatment benefit through the surface of the water in the treatment tank (3) with the optional exhaust fan turned off.

Referring to FIG. 7, to begin treatment the valve on the tasteless smoke cylinder (14) is opened and tasteless smoke containing 30% carbon monoxide begins to flow through a gas delivery system, the details of which are conventional and omitted for clarity. The control valve on the gas regulator (15) is adjusted to the desired gas pressure, which in the present example is 19.1 psi. After setting the control valve on the gas regulator (15) to the operational pressure, the process can be repeated without further adjustments to the regulator.

A gas flow control means is provided with a flow control orifice (16) with a 0.055-inch diameter and a 0.80 flow coefficient C located in a gas delivery tube (17) to cause approximately 1.176 cfm (33.3 liters per minute) of gas flow at 19.1 psi gas pressure. Gas is delivered to bubbling devices (19), preferably 24 in number and preferably identical to those used in aquariums, for the desired period of time to dissolve and entrain carbon monoxide in the water (4) in the treatment tank (3) to produce the desired treatment effect.

The bubbling devices (19) are preferably set at the bottom of the treatment tank (3) and spaced to distribute tasteless smoke gas bubbles (18) throughout. Columns of bubbles (18) extend continuously from the bubbling devices (19) to the surface of the water in the treatment tank (3) such that these columns of bubbles (18) optimally overlap one another.

The operational quantity of bubbles (18) will vary according to a number of factors that include, but are not limited to: bubble size, treatment time, carbon monoxide concentration in the tasteless smoke, and type and size of fish being treated.

Since carbon monoxide, a key component of tasteless smoke, has low water solubility, increasing the quantity and reducing size of the bubbles entrained in the water hasten the effectiveness of tasteless smoke treatment. To maximize the treatment effect and minimize the treatment time, it has been empirically determined that the bubbling means operably entrains gas into at least 10% of the treatment water volume, preferably entrains gas into at least 25% of the treatment water volume, and optimally entrains gas into 40% of the treatment water volume.

In the present example, flow of tasteless smoke continues for approximately 5 minutes, feeding approximately 0.049 cfm (1.39 liters per minute) of tasteless smoke from the control orifice (16) to each of 24 bubbling devices (19). After this delivery period, the gas source valve (14) is turned off. The total gas delivery for the 5-minute cycle is 5.88 cubic feet (166.6 liters) which treats approximately 500 pounds of whole fish, or 85 pounds of whole fish per cubic foot of tasteless smoke.

If higher gas volume is desired, then the pressure from the gas regulator (15) can be increased. Conversely, if a lower gas volume is preferred, then the pressure from the gas regulator (15) can be decreased. For example, increasing the pressure from the gas regulator (15) from 25 psi to 50 psi will increase the gas flow from the flow control orifice (16) to 1.94 cfm (55.0 liters per minute). Decreasing the pressure at the gas regulator (15) will reduce the gas flow. Any alternative means to control flow, dissolve or entrain treatment gas can be substituted.

Optionally, a cylinder of compressed air can be used to flush the treatment gas from the water (4), treatment tank (3) and headspace or ullage (13) after the treatment gas is applied. The optional exhaust fan is turned on during this flushing and turned off after it is complete.

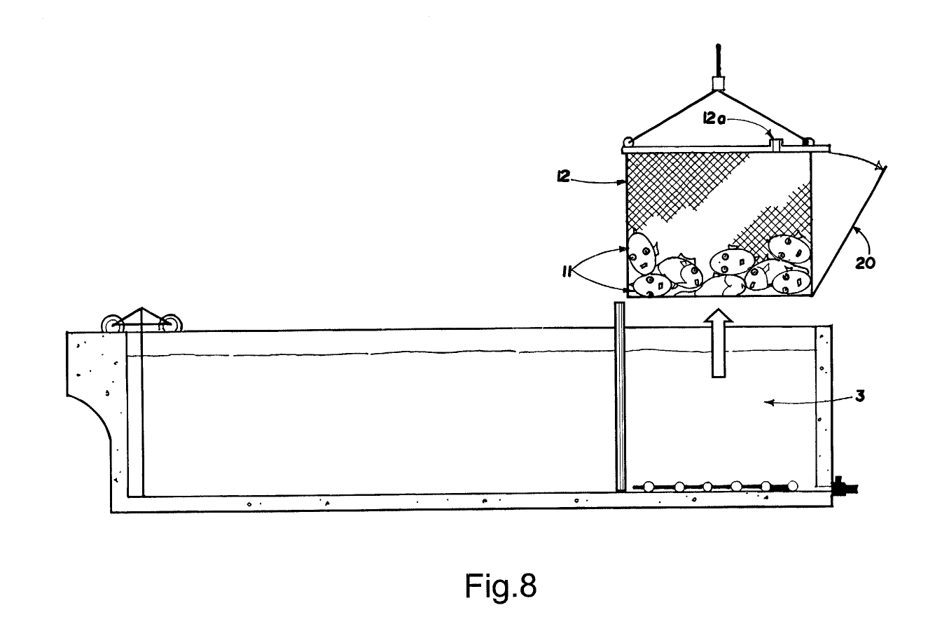

Referring to FIG. 8, the hoist lifts the treatment basket (12) containing the tasteless smoke treated fish (11) from the treatment tank (3). A hanging door (20) on the treatment basket (12) is opened and the treated fish are removed.

It is possible that the fish heart will beat or spasm for a substantial period of time after the fish has been “euthanized” by this process. Under these circumstances a short treatment time quickly followed by a bleeding procedure is desirable, because the heart and other muscle activity after death can act to promote internal bleeding which adversely affects the quality of the meat.

Gas-saving methods to conserve the quantity of treatment gas can be employed, including but not limited to systems to recover gas after it passes through the treatment water for reuse. For example, an optional gas recovery feature can be incorporated by installing a two-way valve in the vent (12a) that leads to a gas storage unit such as a vinyl bladder. The gas delivery means is turned on and the two-way valve is opened to allow gas flow from the headspace or ullage (13) above the surface of the treatment water (4) to the gas storage unit. Alternatively the gas delivery means can be turned on and the two-way valve opened to allow gas flow from the headspace or ullage (13) to be recirculated through the bubbling devices (19).

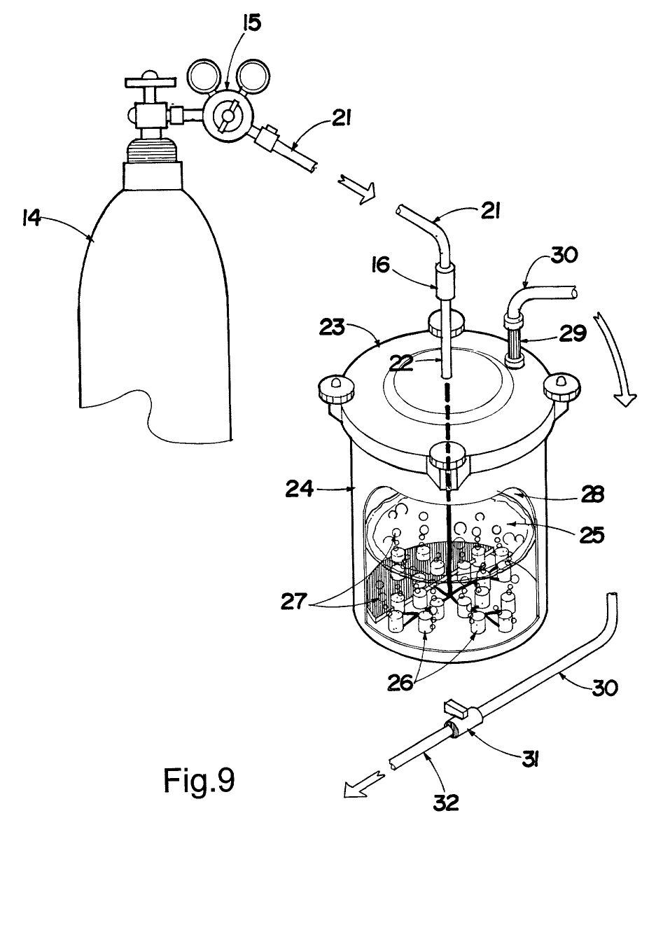

A second method can be used to treat individual fish such as large tuna caught by hook and line. Referring to FIG. 9, a gas foam delivery system begins with a gas source, which in the present example is preferably a compressed cylinder of tasteless smoke with a 30% concentration of carbon monoxide (14). The gas valve is opened, delivering tasteless smoke from the cylinder (14) through the regulator (15). The regulator (15) is adjusted to the desired output pressure and passes gas through tubing (21) that is preferably flexible and suitable to withstand the gas pressure from the regulator (15). The tubing (21) connects to a flow control orifice (16) and inlet pipe (22), delivering gas through an airtight tank lid (23) into a tank (24) filled with a foaming solution (25) through bubbling devices (26). Any other bubbling means such as multiple bubbling devices, agitation, mixers, contactors, mass gas transfer units, or high-pressure devices can be used.

The gas bubbles (27) from the bubbling devices (26) rise to the headspace or ullage (28) above the surface of the foaming solution (25), accumulating foam. Foaming solution (25) is preferably created by mixing one part of dried egg whites with three parts of warm water. However, any other fluid that produces foam can be used as a foaming means.

After filling the headspace or ullage (28) with foam, the gas pressure (15) forces the foam through the outlet pipe (29) and tube (30) connected to a check valve (31). When the check valve (31) is opened the foam flows through the check valve and out an exit tube (32). The tubes before (30) and after (32) the check valve (31) are preferably made of a pressure resistant, non-toxic, corrosive resistant, flexible material such as industrial reinforced rubber. When the check valve (31) is closed the flow of foam stops.

The quantity of foam production is dependent upon several variables including but not limited to: the type of bubbling solution, temperature, pressure, gas consistency, flow rates, tank size, depth of solution, and bubbling devices. In the present configuration the gas pressure (15) is set at 20 psi with a flow control orifice (16) diameter of 1/32 inch and a flow control coefficient of 0.80 delivering a total gas volume of approximately 11.05 liters per minute (0.39 CFM) gas to 20 bubbling devices (26) at a rate of 33.15 liters per hour per bubbling device (26). The tank (24) contains approximately 7.5 gallons or 1 cubic foot (28.33 liters) of foaming solution. Foam is produced at a ratio of approximately 5 parts tasteless smoke and approximately 1 part foaming solution, consuming approximately 2.21 liters per minute of foaming solution. In operation, the 7.5 gallons (28.33 liters) of foaming solution will produce approximately 170.0 liters (45.0 gallons) of foam at a rate of approximately 13.26 liters per minute for 12.8 minutes. Foam volume is increased by 58% by doubling the gas pressure (15) from 20 psi to 40 psi or quadrupled by increasing the flow control orifice diameter (16) from 1/32 inch to 1/16 inch.

Referring to FIGS. 9 and 10, the foaming system is charged with treatment gas pressure and the check valve (31) is opened. The exit tube (32) at the outlet of the check valve (31)is inserted into the mouth (33) or under the gill-plate (34) of the fish (35). The flow of foam is directed to saturate the surface area of the gills (36). Special care is taken not to puncture the heart (37), which transports blood into the ventral aorta (38), through the gills (36) and into the body of the fish (35). Carbon monoxide entrained in foam or dissolved in solution is diffused through the gills (36) into the blood forming COHb. The heart (37) pumps COHb through the dorsal aorta (39) distributing COHb rich blood through the arteries (40) and capillaries (41) into the fish flesh. A portion of carbon monoxide in the blood diffuses from hemoglobin into tissue cells forming COMb. Then, the blood returns through the veins (42) and back to the heart. The process is repeated until the desired treatment effect is achieved.

A full dosage of foam is achieved when the gill (36), buccal, and opercular cavities are completely full of treatment foam. This occurs when overflow foam oozes out of the mouth (33) and from under the gill plate (34). The check valve (31) is closed after the desired amount of foam is administered. Additional dosages can be applied by repeating the application procedure.

After injection the eyes of the fish are covered with a wet cloth to relax it while the treatment gas cures it. Factors affecting curing time include but are not limited to: the type of species, the physical condition of the fish, the type of treatment fluid, the percentage of carbon monoxide in the treatment fluid, the quantity of foam applied, the size of the foam bubbles, the method by which the fish is stored after treatment, the number of dosages, and the time of exposure to the treatment fluid.

It has been found that a maximum treatment effect is achieved with two dosages of treatment foam applied one to three minutes apart for a total 10-minute exposure time, while a substantial treatment effect can be achieved with only one dosage and less than one-minute exposure time. However, in order to bleed the fish more efficiently while still allowing for substantial treatment, it is best to minimize the foam exposure time to less than five minutes while some heart and other muscle activity of the fish continue. After the fish is cured for the desired treatment time the foam is thoroughly washed away and the fish is ready for further processing.

The two illustrated methods are designed to be easily commercialized using ordinary skill and materials. Alternatively, many other mechanical and chemical methods can be applied to dissolve or entrain treatment gases into liquids or foam. For example, venturi injectors and hydraulic mixers can be used to dissolve or entrain treatment gases into liquids thereby reducing the bubble size.

Smaller bubbles of gas dissolve more quickly or stay suspended longer in water, thereby increasing the availability of the treatment gas to the fish. Less gas is needed because the bubbles take longer to dissipate from the water, and the gas is utilized more efficiently by the respiratory system of the fish when it is dissolved or entrained in water in the form of microscopic bubbles.

Inspirable water solutions can be produced by a gas exchange system that dissolves or entrains carbon monoxide gas solute into a liquid solvent. For example, the foaming means can be modified to act as a gas exchange system dissolving and entraining gas into water by reversing the flow.

Referring to FIG. 9, this reverse flow is illustrated with the same apparatus. A reservoir of water (25) fills approximately ½ of the tank (24). Tasteless smoke is provided in the headspace or ullage (28) filling the upper ½ of the tank (24) above the water (25). A water source is attached to the pipe (29) leading into the headspace area or ullage (28) and the pipe (22) extends from just above the inside bottom of the tank (24), through the tank lid (23), and to a check valve (not shown). Pressure from the water source delivers water from the pipe (29) through the headspace or ullage (28) and into the water reservoir (25). When the water pressure is on and the check valve is closed, pressure forces tasteless smoke (28) into the water (25). When the water pressure is on and check valve is open, water is forced out the pipe (22) and through the check valve.

Spray nozzles can be added to the pipe (29) after passing through the tank lid (23) into the tank (24) so water is sprayed through the tasteless smoke (28) promoting absorption of gas (28) into the water (25). A flow control orifice (16) can be added to the pipe (22) restricting water flow from the reservoir (25) when the check valve is opened. The flow control orifice acts to meter water output and maintains pressure between the gas (28) and the water (25) in the reservoir when the check valve is opened and the system is in operation.

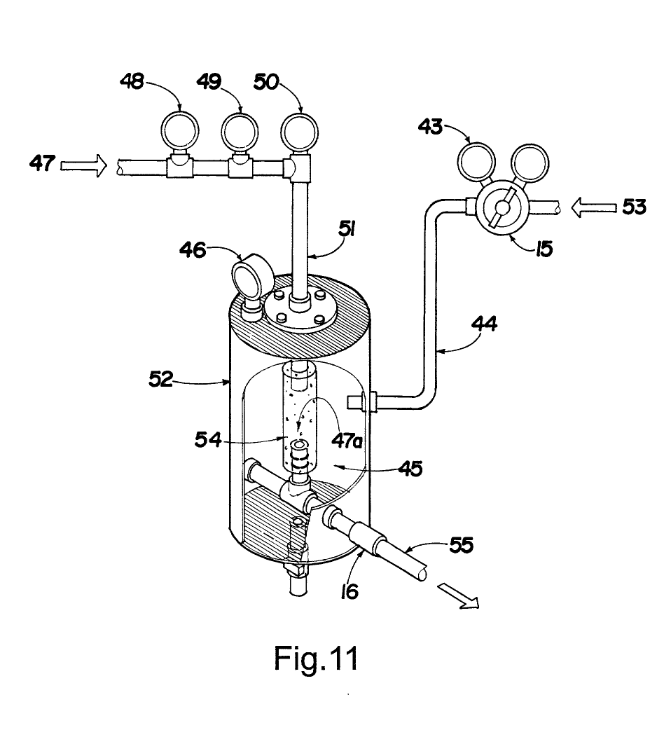

Referring to FIG. 11, a gas exchange system provides pressurized tasteless smoke through a regulator (15) at an output pressure shown on the gauge (43) that leads through a pipe (44) to the airtight area inside the gas exchange chamber (45) at a temperature shown on the gauge (46). Solvent (47) under pressure (48) at a flow rate (49) and temperature (50) is regulated through a pipe (51) that passes through the walls of the airtight gas exchange chamber (52).

Tasteless smoke (53) under pressure (43) inside the gas exchange chamber (45) passes through a porous gas permeable and liquid impermeable section of pipe (54) and dissolves into the solvent (47a). The amount of gas (53) that dissolves into a unit of solvent (47a) is determined by factors including the gas pressure (43), solvent pressure (48), temperatures (43 and 49), pipe diameter (51), solvent flow rate (49), solubility of the gas, permeability of the pipe (54), and other solutes in the solution.

A flow control orifice (16) can be added to the outlet pipe (55) to meter the water solution output and maintain water pressure (47a) inside the pipe (54). The pipe (54) can have a greater diameter than pipes (51 and 55) thereby increasing its surface for gas transfer and reducing the speed of solvent (47a) flowing through it. The solvent (47a) circulating through the pipe (54) dissolves the tasteless smoke (53) in to a solution.

A 12 inch length of tubing (54) with a diameter of 2 inches and a gas permeability ranging from 500 cubic centimeters per hour to 600 cubic centimeters per minute per square meter, at temperatures (43 and 49) of 24 degrees Centigrade, and a gas pressure (43) ranging from 15 to 500 PSI will meter approximately 17.63 ml carbon monoxide per liter of water solution at rates ranging from approximately 3 liters per hour to 60 liters per minute.

A further alternative effectively introduces a treatment medium directly into the respiratory system of whole live fish. A hose leading from a treatment gas source into the mouth of a fish floods the mouth and gill cavity with a treatment gas such as tasteless smoke. However, gas consumption, safety, and efficiencies of treating water-breathing animals with pure gas are considerations. All water breathing and air-breathing animals can be treated according to the present invention.

The gas treatment procedure for air breathing animals simply involves connecting treatment gas source to a respirator gas mask that supplies the treatment gas to the animal for breathing. When the animal breathes a treatment gas such as pure tasteless smoke containing 30% carbon monoxide death occurs along with treatment of the meat.

Still further methods can be employed to bypass the heart and/or respiratory system by using means to artificially create carboxyhemoglobin in a blood plasma base outside of the animal, and then to pump this carbon monoxide-rich plasma through the animal for treatment. Such a method can be used shortly after the death of the animal.

### INDUSTRIAL APPLICABILITY

All of these methods and alternatives relate to treating the meat of animals with a treatment medium through their functioning respiratory and circulatory systems while alive, and treating through their internal physiological structure by artificial means after death. Such methods and alternatives are included within the scope of the invention.

What is claimed is:

1. A process for treating meat comprising:
an animal;
a treatment gas;
Introducing said treatment gas through said animals respiratory and circulatory systems into said meat;
said treatment gas preserves said meat.

2. A process for treating meat comprising:
a live animal;
treatment fluid;
said live animal inhales said treatment fluid;
said treatment fluid diffuses into the blood of said animal;
said treatment fluid preserves said meat.

3. A process for treating edible meat comprising:
a meat bearing animal;
fluid containing smoke gas is exposed to the respiratory system of said animal;
an element of said smoke gas diffuses through the respiratory system into the blood of said animal and flows into said meat;
said smoke gas preserves said edible meat.

4. A process for treating meat comprising:
a live animal;
dissolving a treatment gas into a liquid;
said dissolved treatment gas is introduced to the circulatory system and circulated throughout said animal;
said treatment dissolved gas preserves said meat for food.

5. A process for treating meat comprising;
solvent;
gas solute;
said gas is dissolved in said solvent forming a solution;
said solution is applied to the circulatory system of an animal;
obtaining a treatment effect to said meat of said animal.

6 A process according to claim 1, wherein said animal is frozen whole.

7. A process according to claim 1, wherein said meat is frozen.

8. A process according to claim 1, further comprising:
said gas contains carbon monoxide;
said carbon monoxide diffuses into the blood of said animal and binds with hemoglobin forming COHb.
said blood containing COHb flows through the circulatory system into said meat and COMb is formed;

9. A process according to claim 1, further comprising:
said gas kills or sedates said animal for harvesting.

10. A process according to claim 1, wherein said animal is seafood.

11. A process according to claim 1, wherein said animal is fish.

12. A process according to claim 1, wherein said animal is beef, pork, or fowl.

13. A process according to claim 11, wherein said fish is salmon, tuna, or tilapia.

14. A process according to claim 1, further comprising:
said animal has gills;
said animal ventilates water through said gills.

15. A process according to claim 1, further comprising:
said animal has lungs;
said animal ventilates said gas through said lungs;
said respiration occurs through said lungs.

16. A process according to claim 14 further comprising:
said gas is entrained into foam colloid;
said foam colloid is applied to said gills.

17. A process according to claim 1, wherein said preservation is applied by mass-treatment of groups of said animals.

18. A process according to claim 1, further comprising: said gas is derived from raw smoke; water and animal membranes act to super-purify said smoke preventing smoke flavor from being imparted to said meat.

19. A process according to claim 1, wherein treatment occurs after said animal is dead.

20. A process according to claim 1, further comprising:
said gas is pumped through said circulatory system by a heart;
bleeding said animal begins before said heart stops pumping.

21. A process according to claim 1, further comprising:
said gas is contained in capsules;
said gas capsules are introduced into said circulatory system through the digestive track.

22. A process according to claim 1, further comprising:
an artificial means of respiration replacing said respiratory system.

23. A process according to claim 22, further comprising:
an artificial pump replacing said heart.

24. A process according to claim 14, further comprising:
said gas is entrained in water;
a portion of said entrained gas is dissolved in said water;
said water inspires during said ventilating.

25. A process according to claim 14, further comprising:
a gas solute;
a liquid solvent;
said gas solute and said liquid solvent are in contact at a pressure above one atmosphere;
said gas solute dissolves in said liquid solvent forming a solution;
said solution is applied to said gills.

26. A process according to claim 15, further comprising:
a respirator;
said treatment gas is supplied by said respirator to said lungs;
said gas is diffused into the blood during said ventilating.

27. A process according to claim 11, further comprising:
foam containing said gas;
removing said fish from water and applying said foam to the gills of said fish.

28. A process according to claim 14, further comprising:
said animal inspires water containing concentrations greater than 80 nl of carbon monoxide per liter of said inspired water.

29. A process according to claim 8, further comprising:
blood of said animal contains COHb concentration ranging between approximately 5% and 100%.

30. A process according to claim 14, further comprising:
said animal inspires water containing carbon monoxide for a duration ranging from approximately a few seconds to several hours.

31. A process according to claim 14, further comprising:
said animal inspires water containing carbon monoxide for a duration ranging from approximately 1.5 minutes to 1 hour.

32. A process according to claim 28, further comprising:
said animal containing blood;
said carbon monoxide diffuses from said inspired water into said blood and COHb concentration increases;
subsequently, said animal inspires water with less than 80 nl of carbon monoxide per liter;
said carbon monoxide diffuses from said blood into said inspired water with less than 80 nl of carbon monoxide and said COHb concentration decreases.

33. A process according to claim 14, further comprising:
liquid;
carbon monoxide gas combined with liquid making a foam colloid solution;
said foam colloid solution is applied to said gills.

34. A process according to claim 33, further comprising:
ratio of said gas to said liquid ranges from between approximately 1:1 to 10:1;
said animal is living in biologically suitable water:
said animal is removed from said biologically suitable water before said foam colloid solution is applied to said gills;
said respiratory and circulatory activity lingers for a treatment duration ranging from approximately 3 minutes to 20 minutes after said animal is removed from said biologically suitable water.

35. A process according to claim 34, wherein said foam colloid solution is exposed to said gills for a duration ranging from approximately 10 seconds to 30 minutes.

36. A process according to claim 11, further comprising:
said gas contains carbon monoxide:
said treated fish meat is fish having carbon monoxide concentrations ranging from between approximately 1.1 to 20 times the quantity of carbon monoxide in untreated fish meat.

37. A process according to claim 11, further comprising:
said gas includes carbon monoxide;
said treated fish meat having carbon monoxide concentrations ranging from between approximately 1.1 to 80 times the quantity of carbon monoxide in untreated fish meat.

38. A process according to claim 8, further comprising:
intensity of said meat treatment controlled by varying the COHb.

39. A process according to claim 14, further comprising:
carbon monoxide dissolved in respirable water;
said animal ventilates said respirable water producing COHb;
intensity of treatment and carbon monoxide content in said meat is regulated by varying said carbon monoxide concentration in said respirable water, and;
varying said ventilation time.

40. A process according to claim 8, further comprising:
said animal is a fish;
said gas is dissolved in a liquid solution and inspired by said fish;
said inspired solution contains sufficiently high concentrations of carbon monoxide to cause approximately 100% COHb production for the total volume of blood passing through the gills during ventilation;
time of said ventilation multiplied by cardiac output determines total milliliters COHb per kilogram of body weight;
said total milliliters COHb per kilogram of body weight produced divided by total Hb per kilogram of body weight, equals average COHb saturation;
maximum saturation is 100% COHb.

41. A process according to claim 8, further comprising:
said animal is fish;
carbon monoxide concentration in said treated meat range from between approximately 1.1 to 3.99 times carbon monoxide concentration in untreated meat.

42. A process according to claim 8, further comprising:
said animal is fish;
carbon monoxide concentration in said treated meat range from between approximately 4 to 9.99 times carbon monoxide concentration in untreated meat.

43. A process according to claim 1, further comprising:
said animal is a tuna ventilating a fluid containing carbon monoxide;
carbon monoxide concentration of said tuna meat ranges from between approximately 22 μg/kg to 957 μg/kg.

44. A process according to claim 1, further comprising:
said animal is a tuna ventilating a fluid containing carbon monoxide;
carbon monoxide concentration of the flesh of said tuna range from between approximately 44 μg/kg to 399 μg/kg.

45. A process according to claim 1, further comprising:
said animal is a tuna ventilating a fluid containing carbon monoxide;
carbon monoxide concentration of the flesh of said tuna range from between approximately 80 μg/kg to 2,397 μg/kg.

46. A process according to claim 1, further comprising:
said animal is a tuna ventilating a fluid containing carbon monoxide;
carbon monoxide concentration of the flesh of said tuna range from between approximately 160 μg/kg to 999 μg/kg.

47. A process according to claim 1, further comprising:
said animal is a tuna ventilating a fluid containing carbon monoxide;
carbon monoxide concentration of the flesh of said tuna range from between approximately 200 μg/kg to 4,800 μg/kg.

48. A process according to claim 1, further comprising:
said animal is a tuna ventilating a fluid containing carbon monoxide;
carbon monoxide concentration of the flesh of said tuna range from between approximately 400 μg/kg to 2,000 μg/kg.

49. A process according to claim 1, further comprising:
said animal is a tilapia ventilating a fluid containing carbon monoxide;
carbon monoxide concentration of the flesh of said tilapia range from between approximately 6.6 μg/kg to 60 μg/kg.

50. A process according to claim 1, further comprising:
said animal is a tilapia ventilating a fluid containing carbon monoxide;
carbon monoxide concentration of the flesh of said tilapia range from between approximately 7.7 μg/kg to 40 μg/kg.

51. A process according to claim 1, further comprising:
said animal is a tilapia ventilating a fluid containing carbon monoxide;
carbon monoxide concentration of the flesh of said tilapia range from between approximately 24 μg/kg to 150 μg/kg.

52. A process according to claim 1, further comprising:
said animal is a tilapia ventilating a fluid containing carbon monoxide;
carbon monoxide concentration of the flesh of said tilapia range from between approximately 28 μg/kg to 99.9 μg/kg.

53. A process according to claim 1, further comprising:
said animal is a tilapia ventilating a fluid containing carbon monoxide; carbon monoxide concentration of the flesh of said tilapia range from between approximately 60 μ/kg to 300 μg/kg.

54. A process according to claim 1, further comprising:
said animal is a tilapia ventilating a fluid containing carbon monoxide;
carbon monoxide concentration of the flesh of said tilapia range from between approximately 70 μg/kg to 200 μ/kg.

55. A process according to claim 1, further comprising:
said animal is a tilapia ventilating a fluid containing carbon monoxide;
carbon monoxide concentration of the flesh of said tilapia range from between approximately 300 μg/kg to 1,200 μg /kg.

56. A process according to claim 14, further comprising:
said gas is dissolved in said water;
volume of said dissolved gas is expressed by a formula;
said formula is: vo=absorption coefficient×(V×Po).

57. A process according to claim 14, further comprising:
said animal ventilates water;
said gas is dissolved in said water;
coefficient of solubility formula defined as:
“Vo=(v×Pg×To)/T”.

58. A process according to claim 14, further comprising:
said gas is carbon monoxide dissolved in said water;
gill absorption of said dissolved carbon monoxide is defined in a formula;
said formula is: CO gill absorption=(cardiac output*(Hb*1.39*%sat)*wt)+((cardiac output*(0.029*PCO)/100)*wt)

59. A process according to claim 14, further comprising:
said gas is carbon monoxide dissolved in said water;
said carbon monoxide gill absorption/kg=18.35 mlCO/min/kg.

60. A process according to claim 14, further comprising:
said animal is a tuna;
said gas is carbon monoxide dissolved in said water;
said tuna tissue ranges from approximately 22 to 957 μg CO/kg;
said tuna tissue ranges from approximately 018 to 0.766 mlCO/kg;
said tuna blood ranges from approximately 2.07 to 4.94 mlCO/kg.

61. A process according to claim 14, further comprising:
said animal is a tuna;
said gas is carbon monoxide dissolved in said water;
said tuna tissue ranges from approximately 44 to 399 μg CO/kg;
said tuna tissue ranges from approximately 0.035 to 0.319 mlCO/kg;
said tuna blood ranges from approximately 2.07 to 3.99 mlCO/kg.

62. A process according to claim 14, further comprising:
said animal is a tuna;
said gas is carbon monoxide dissolved in said water;
said tuna tissue ranges from approximately 80 to 2,397 μg CO/kg;
said tuna tissue ranges from approximately 0.064 to 1.919 mlCO/kg;
said tuna blood ranges from approximately 7.34 to 12.36 mlCO/kg.

63. A process according to claim 14, further comprising:
said animal is a tuna;
said gas is carbon monoxide dissolved in said water;
said tuna tissue ranges from approximately 160 to 399 μg CO/kg;
said tuna tissue ranges from approximately 0.128 to 0.800 mlCO/kg;
said tuna blood ranges from approximately 7.34 to 9.97 mlCO/kg.

64. A process according to claim 14, further comprising:
said animal is a tuna;
said gas is carbon monoxide dissolved in said water;
said tuna tissue ranges from approximately 200 to 4,800 μg CO/kg;
said tuna tissue ranges from approximately 0.160 to 3.840 mlCO/kg;
said tuna blood ranges from approximately 18.34 to 24.72 mlCO/kg.

65. A process according to claim 14, further comprising:
said animal is a tuna;
said gas is carbon monoxide dissolved in said water;
said tuna tissue ranges from approximately 400 to 2,000 μg CO/kg;
said tuna tissue ranges from approximately 0.320 to 1.601 mlCO/kg;
said tuna blood ranges from approximately 18.34 to 19.94 mlCO/kg.

66. A process according to claim 14, further comprising:
said animal is a tilapia;
said gas is carbon monoxide dissolved in said water;
said tilapia tissue ranges from approximately 6.6 to 60 μg CO/kg;
said tilapia tissue ranges from approximately 0.005 to 0.048 mlCO/kg;
said tilapia blood ranges from approximately 0.18 to 0.86 mlCO/kg.

67. A process according to claim 14, further comprising:
said animal is a tilapia;
said gas is carbon monoxide dissolved in said water;
said tilapia tissue ranges from approximately 7.7 to 40 μg CO/kg;
said tilapia tissue ranges from approximately 0.006 to 0.032 mlCO/kg;
said tilapia blood ranges from approximately 0.18 to 0.53 mlCO/kg.

68. A process according to claim 14, further comprising:
said animal is a tilapia;
said gas is carbon monoxide dissolved in said water;
said tilapia tissue ranges from approximately 2.4 to 150 μg CO/kg;
said tilapia tissue ranges from approximately 0.019 to 0.120 mlCO/kg;
said tilapia blood ranges from approximately 0.44 to 2.10 mlCO/kg.

69. A process according to claim 14, further comprising:
said animal is a tilapia;
said gas is carbon monoxide dissolved in said water;
said tilapia tissue ranges from approximately 2.8 to 100 μg CO/kg;
said tilapia tissue ranges from approximately 0.022 to 0.080 mlCO/kg;
said tilapia blood ranges from approximately 0.44 to 1.31 mlCO/kg.

70. A process according to claim 14, further comprising:
said animal is a tilapia;
said gas is carbon monoxide dissolved in said water;
said tilapia tissue ranges from approximately 60 to 1,200 μg CO/kg;
said tilapia tissue ranges from approximately 0.048 to 0.961 mlCO/kg;
said tilapia blood ranges from approximately 3.20 to 15.11 mlCO/kg.

71. A process according to claim 14, further comprising:
said animal is a tilapia;
said gas is carbon monoxide dissolved in said water;
said tilapia tissue ranges from approximately 70 to 200 μg CO/kg;
said tilapia tissue ranges from approximately 0.056 to 0.160 mlCO/kg;
said tilapia blood ranges from approximately 3.20 to 9.41 mlCO/kg.

72. A process according to claim 8, further comprising:
said animal is a tuna;
the ratio of COHb to COMb in said tuna ranges from approximately 5:1 to 153:1.

73. A process according to claim 8, further comprising:
said animal is a yellowfin fish;
the ratio of COHb to COMb in said yellowfin tuna ranges from approximately 11:1 to 68:1.

74. A process according to claim 8, further comprising:
said animal is a tilapia;
the ratio of COHb to COMb in said tilapia ranges from approximately 11:1 to 67:1.

75. A process according to claim 8, further comprising:
said animal is a tuna;
the ratio of COHb to COMb in said tuna averages approximately 9.9:1.

76. A process according to claim 8, further comprising:
said animal is a yellowfin fish;
the ratio of COHb to COMb in said yellowfin tuna averages approximately 18.7:1.

77. A process according to claim 8, further comprising:
said animal is a tilapia;
the ratio of COHb to COMb in said tilapia averages approximately 9.9:1.

78. A process according to claim 14, further comprising:
minimum treatment time is 8 seconds.

79. A process according to claim 14, further comprising:
minimum treatment time is 14 seconds.

80. A process according to claim 14, further comprising:
CO gill absorption=(115*(0.11*1.39*100%)*1)+((115*(0.0029*228)/100)*1)=17.58+0.76 mlCO/min=18.34 mlCO/min.

81. A process according to claim 11, further comprising:
CO gill absorption/kg=18.34 mlCO/min/kg.

82. A process according to claim 1, further comprising:
said treated meat replicates natural coloration and subsequent discoloration of untreated meat.

83. A process according to claim 14, further comprising:
COHb concentration in said animals' blood is controlled by regulating carbon monoxide concentrations in said water and rate of said ventilation.

84. A process according to claim 14, further comprising:
said animal is tuna;
said ventilated water contains no less than 0.092 mlCO/liter H₂O.

85. A process according to claim 14, further comprising:
said animal is tuna;
said ventilated water contains no less than 0.882 mlCO/liter H₂O.

86. A process according to claim 14 further comprising:
said animal is tuna;
said ventilated water contains no less than 2.646 mlCO/liter H₂O.

87. A process according to claim 14 further comprising:
said animal is tilapia;
said ventilated water contains no less than 0.008 mlCO/liter H₂O.

88. A process according to claim 14 further comprising:
said animal is tilapia;
said ventilated water contains no less than 0.176 mlCO/liter H₂O.

89. A process according to claim 14 further comprising:
said animal is tilapia;
said ventilated water contains no less than 1.408 mlCO/liter H₂O.

90. An apparatus for a solution used to treat meat comprising;
solvent;
gas solute;
a means to dissolve said gas into said solvent;
said gas solute is dissolved in said solvent forming said treatment solution.

91. An apparatus comprising:
a treatment tank;
water contained in said treatment tank;
fish contained in said water;
carbon monoxide gas dissolved in said water;
fish respire said water containing dissolved carbon monoxide;
said carbon monoxide causes a treatment affect to the meat of said fish.

92. An apparatus for treating meat comprising;
a container;
said container containing a colloid solution;
carbon monoxide gas entrained in said colloid solution;
said carbon monoxide colloid solution applied to seafood;
the meat of said seafood obtaining a treatment effect.
